(19) United States
(12) Patent Application Publication
(10) Pub. No.: US 2004/0223626 A1
(43) Pub. Date: Nov. 11, 2004

(54) Method for embedding spatially variant metadata in imagery

(75) Inventors: Chris W. Honsinger, Ontario, NY (US); Robert J. Parada JR., Rochester, NY (US); Peter D. Burns, Fairport, NY (US); Belimar Velazquez, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/434,780

(22) Filed: May 9, 2003

(51) Int. Cl. G06K 9/00

(52) U.S. Cl. 382/100

(57) ABSTRACT

A method of steganographic encoding data into an image which encoded data is related to image processing functions that may be used to process the image, the method comprises the steps of providing a dispersed message dimension; providing a grid spacing value; providing an array of object identifiers and associated object locations based on the grid spacing value; embedding an object identifer at a first location into the image; embedding a second object identifier at a second location, wherein the the second location is an integer, non-zero multiple of the grid spacing value.

### FIELD OF THE INVENTION

The invention relates generally to the field of image processing, and in particular to embedding high-resolution metadata in an image. The invention utilizes aspects of data embedding. The science or art of data embedding is also referred to as data hiding, information hiding, data embedding, watermarking and steganography.

### BACKGROUND OF THE INVENTION

The human species is apt at picking out features in images and video and processing specialized information about them. A human focuses on the face in a portrait, for example, before he processes the information in the background. A human being can find and interpret features in images exponentially faster than electronic computers. Often, presentation of pictures in the most meaningful and esthetically pleasing fashion requires image processing that is different depending on the specific feature within a picture. A simplistic example would be to blur the background of a portrait and sharpen the area containing a face.

Often, it is desirable to process the image depending on the target device. For example, the portrait presented on a CRT screen could have different sharpening and smoothing parameters than the same portrait presented on a high quality print. One could pre-classify the image in face and background regions and include the coordinates of the class mapping in the file header and have each device process the regions consistent with its own characteristics.

A problem with this approach is that most file formats do not support the storage of classification information. Also, in an Internet environment where image data is often processed by many software programs before it is exploited, the numerous programs would have to recalculate the feature location information every time the image is cropped or rotated, for example.

Another example of an area where feature classification is of central importance is in remote sensing. Classification of image areas by vegetation character, residential area, waterways, industrial, and the like is of importance for city planners, prospective homeowners, and business applications. Remote sensing data is often many bands of data. For example, Landsat has seven bands as opposed to conventional images that have three. The computer infrastructure of today is not friendly toward remote sensing imagery; most software, nearly all popular software, is not at all compatible with this kind of data.

Special and complex software is required to classify image data. If the classification information were somehow included in the image itself, then multiple edits of the images could be performed without worry about losing the data or its meaning. The special and complex software could be replaced by programs that simply extract the classification information.

The present invention provides a solution to these problems by the use of data embedding.

### SUMMARY OF THE INVENTION

A method of encoding feature information in an image is provided that can be used later to enhance or improve the image.

### BRIEF DESCRIPTION OF THE DRAWINGS

FIG. 1 illustrates an example of a binary and iconic message image;

FIG. 2 illustrates the reciprocal of the Contrast Sensitivity Function (CSF);

FIG. 3 illustrates a picture of a face;

FIG. 4 illustrates a diagram demonstrating the components of a system of the present invention;

FIG. 5 illustrates a picture of a face divided in blocks;

FIG. 6 illustrates the prior art way of abutting dispersed messages (prior art tiles) next to each other;

FIG. 7 illustrates the concept of staggering dispersed messages; and

FIG. 8 illustrates a computer system for implementing the present invention.

### DETAILED DESCRIPTION OF THE INVENTION

It is noted that the present invention may be performed in processing an image having either individually or in any combination the image processing steps of scene balance, tone scale manipulation, sharpness adjustment, noise reduction, and/or defect correction.

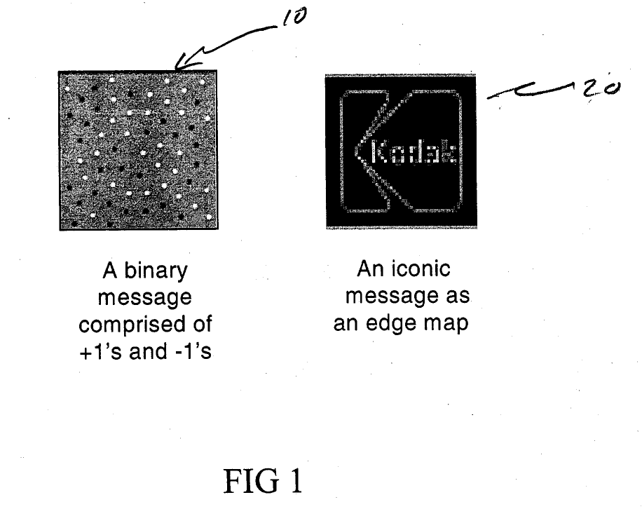

A preferred data embedding technique is disclosed in Honsinger, et al., U.S. Pat. No. 6,044,156, issued Mar. 28, 2000, entitled “Method For Generating An Improved Carrier For Use In An Image Data Embedding Application.” Here, an original image is represented as the two-dimensional array, I(x,y), the embedded image, I′(x,y), and a carrier is defined as C(x,y). A message that is embedded, M(x,y), in its most general form is an image. The message can represent an icon, for example, a trademark, or may represent the bits in a binary message. In the latter case, the on and off states of the bits are represented as plus and minus ones, or positive and negative delta functions (spikes) which are placed in predefined and unique locations across the message image. An example of a binary 10 and iconic message 20 image is shown in FIG. 1. Examples of iconic data types are trademarks, corporate logos or other arbitrary images. Performance generally decreases as the message energy increases so edge maps of the icons are used. In the present invention only binary data types are used. Examples of binary data types are 32 bit representations of URL's, and copyright ID codes, or authentication information.

With these definitions the preferred embedding equation is:

I′(x,y)=α(M(x,y)*C(x,y))+I(x,y), (1)

where the symbol, *, represents circular convolution and α is an arbitrary constant chosen to make the embedded energy simultaneously invisible and robust to common processing. From Fourier theory, spatial convolution in the frequency domain is the same as adding phase while multiplying magnitudes. Therefore, the effect of convolving the message with a carrier is to distribute the message energy in accordance with the phase of the carrier and to modulate the amplitude spectrum of the message with the amplitude spectrum of the carrier. If the message were a single delta function and the carrier of random phase and of uniform Fourier magnitude, the effect of convolving with the carrier would be to distribute the delta function over space. Similarly, the effect of convolving a message with a random phase carrier is to spatially disperse the message energy.

The preferred extraction process is to correlate with the same carrier used to embed the image:

I′(x,y) [symbol] C(x,y)=α(M(x,y)*C(x,y)) [symbol] C(x,y)+I(x,y) [symbol] C(x,y), (2)

where the symbol, [symbol] , represents circular correlation. Correlation is similar to convolution in that Fourier magnitudes also multiply. In correlation, however, phase subtracts. Therefore, the phase of the carrier subtracts on correlation of the embedded image with the carrier leaving the message. Indeed, if we assume that the carrier is designed to have uniform Fourier amplitude, then, and the process of correlation of the carrier on the embedded image Eq. 2, can be reduced to:

I′(x,y) [symbol] C(x,y)−αM(x,y)+noise (3)

That is, the process of correlation of the embedded image with the carrier reproduces the message image plus noise due to the cross correlation of the image with the carrier.

Tiling the dispersed message on the original image improves the robustness of the algorithm. In the mentioned prior art, a single 128×128 dispersed message is tiled over the entire image. Upon extraction, each 128×128 region is aligned and summed to produce the final message. As disclosed in co-pending U.S. Ser. No. 09/453,247, filed Dec. 2, 1999, entitled “Method And Computer Program For Extracting An Embedded Message From A Digital Image,” by Chris W. Honsinger, for imaging applications with severe quality loss, such as small images printed using ink-jet printers on paper, a weighting factor that depends on the estimated signal to noise ratio can be calculated and applied to each extracted message element before summation.

If the extracted message is denoted as M′(x,y), the equations for extracting the message (Eq. 2 and Eq. 3) above can be rewritten, as:

M′(x,y)=αM(x,y)*(C(x,y) [symbol] C(x,y))+noise (4)

The above equation suggests that the resolution of the extracted message is fundamentally limited by the autocorrelation function of the carrier, C(x,y) [symbol] C(x,y). Any broadening of C(x,y) [symbol] C(x,y) from a delta function will blur the extracted message when compared to the original message. Another way to view the effect of the carrier on the extracted message is to consider C(x,y) [symbol] C(x,y) as a point spread function, since convolution of the original message with C(x,y) [symbol] C(x,y) largely determines the extracted message.

The design of the carrier should consider both the visual detectability of the embedded signal and the expected signal quality at the extraction step. There is clearly a design tradeoff between achieving optimum extracted signal quality and embedded signal invisibility.

A carrier designed for optimal extracted signal quality will possess increasing amplitude with increasing spatial frequency. This may be derived from the well-known characteristic of typical images that the Fourier amplitude spectrum falls as the inverse of spatial frequency. At low spatial frequencies, where typical images have their highest energy and influence on the extracted image, our carrier uses this result. In particular, the mean or DC frequency amplitude of our carrier is always zero. As spatial frequency is increased, the carrier amplitude envelope smoothly increases with increasing spatial frequency until about 1/16 to 1/5 Nyquist.

For frequencies greater than this, the carrier envelope can optionally be derived from a Contrast Sensitivity Function (CSF). Use of the CSF in an image embedding application is described in detail in Daly, U.S. Pat. No. 5,905,819, issued May 18, 1999, entitled “Method And Apparatus For Hiding One Image Or Pattern Within Another”.

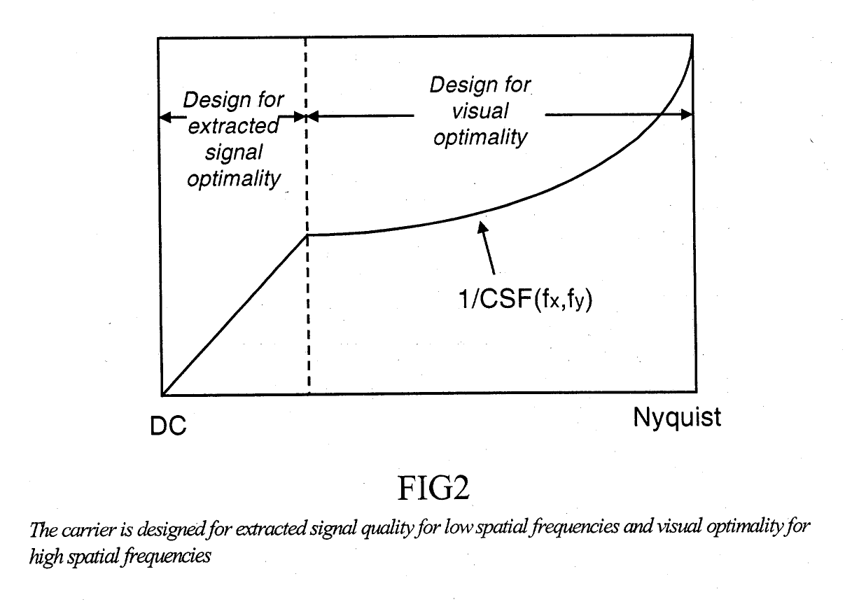

The CSF provides a measure of the sensitivity of the average observer to changes in contrast at a given spatial frequency. The reciprocal (FIG. 2) of the CSF can be used to prescribe the amount of amplitude needed for the embedded signal to be detectable by an average viewer. Many modern CSF models facilitate for observer viewing distance, background noise, receiver dot density, color component wavelength and other factors.

Use of these CSF parameters can be an advantage when optimizing an embedding algorithm for a specific application. One particularly useful way of sizing the embedding algorithm for a specific system is to define the quality of the embedded signal in terms of the viewing distance at which the embedded signal can be visually detected. Once this is defined, an optimized carrier can be immediately derived and tested.

For a binary message, the impact of this carrier envelope is to produce a very small sidelobe around each delta function. It may be argued that the sidelobes rob the algorithm of bandwidth. However, we have found that the destructive processes of compression, error diffusion, printing and scanning have a far greater influence on the bandwidth of the algorithm. In a binary message, these destructive processes are the limiting factor of the bit density and can be thought of as defining the minimum separation distance between the delta functions. So long as the sidelobes are confined within half of the minimum bit separation distance, sidelobe interference may be considered minimal.

Correcting for rotation, scaling and skew is a fundamental element of all robust data embedding techniques. In Honsinger, et.al, U.S. Pat. No. 5,835,639, issued Nov. 10, 1998, entitled “Method For Detecting Rotation and Magnification In Images,” a preferred method of correction of rotation and scale is provided. The correction technique relies on autocorrelation of the embedded image. For example, upon autocorrelation of an embedded image that has not been rotated or scaled, we would expect to see correlation peaks spaced horizontally and vertically at intervals of 128 pixels and 128 lines. At the zero offset correlation point, there is a very high peak due to the image correlating with itself.

Now, if the embedded image is scaled, the peaks must scale proportionately. Similarly, if the embedded image is rotated, the peaks must rotate by the same amount. Therefore, the rotation and scale of an image can be deduced by locating the autocorrelation peaks. Detection of the actual rotation angle θ is limited to angles in the range (−45°,+45°]. However, the actual rotation angle will be a member of the set θ_{actual}=θ_{calculated}±n90°, where n is an integer. Because we test for the possibility that the image has been flipped or rotated in increments of 90 degrees during the message extraction process, this ambiguity is not a fundamental limitation.

The effect of the autocorrelation properties of the original image can be significant. Without ancillary processing, high amplitude low frequency interference in the autocorrelation image can make the process of detecting peaks difficult. To minimize this problem, practice of the invention disclosed in U.S. Ser. No. 09/452,415, filed Dec. 1, 1999, entitled “Method and Computer Program For Detecting Rotation and Magnification of Images,” by Chris W. Honsinger is performed. Here, localized first order and second order moment normalization on the embedded image is applied before the autocorrelation. This process consists of replacing each pixel in the image with a new pixel value, ν_{new}:

$${v}_{new} = \frac{{σ}_{desired}}{{σ}_{old}} ( {v}_{old} - {m}_{old} ) \qquad 5 )$$

where ν_{old}, is the original pixel value, m_{old}, is the local mean of the image, σ_{desired} is the desired standard deviation, which is generally set to the expected embedded signal standard deviation and σ_{old} is the local standard deviation. Because this operation is over a small area, typically over a (3×3) or (5×5) region, its effect in removing the high amplitude, low frequency coherent noise is quite substantial. For the limiting case when σ_{old}→0, we simply equate ν_{new} to a value taken from a random noise generator having a standard deviation σ_{desired}.

The next piece of ancillary processing performed is to shape the autocorrelation peaks also described in Honsinger, et.al, U.S. Pat. No. 5,835,639, and in Honsinger, U.S. Ser. No. 09/452,415. This is done during the FFT operation used in the autocorrelation processing. A function that increases linearly with spatial frequency in the Fourier magnitude domain is quite satisfactory. This function is consistent with a Wiener filter designed to maximize the semblance of the correlation peaks to delta functions under the assumption that the image Fourier amplitude spectrum exhibits an asymptotic “1/(spatial frequency)” falloff. Following these processing steps produces peaks that need little further processing.

Importantly, because autocorrelating the embedded image requires no extra calibration signal, it does not tax the information capacity of the embedding system. In the art and science of steganography, reserving as much information for the data it is wished to convey is of paramount importance. Because of this, using the autocorrelation technique provides a significant improvement over the teachings of Rhoads, U.S. Pat. No. 5,832,119, issued Nov. 3, 1998, entitled “Methods For Controlling Systems Using Control Signals Embedded In Empirical Data,” because for this system a “subliminal graticule” or extra signal must be used to correct for rotation or scale.

The ability to recover from cropping is an essential component of a data embedding algorithm. As disclosed in copending application U.S. Ser. No. 09/453,160, filed Dec. 2, 1999, entitled “Method and Computer Program for Embedding and Extracting An Embedded Message From A Digital Image,” by Chris W. Honsinger, if an arbitrarily located 128×128 region of an embedded image is extracted, the extracted message would probably appear to be circularly shifted due to the unlikely chance that the extraction occurred along the original message boundary.

Indeed, if the origin of the 128×128 extracted region was a distance, (Δx,Δy), from its nearest “original” origin, then the extracted message, M′(x,y) can be written as:

M′(x,y)=M(x,y)*δ(x−Δx,y−Δy) (6)

where it is assumed that the convolution is circular, that the carrier autocorrelated to a delta function and that the image contributes no noise.

On the surface, this circular shift ambiguity is a severe limitation on data capacity because it imposes the constraint that the message structure must be invariant to cyclic shifts. However, a way around this is found in U.S. Ser. No. 09/453,160 which places the bits in the message in a special manner. First, required is a message template, that is, a prescription of where to place the bits in a message image. The message template is derived by placing positive delta functions on a blank 128×128 image such that each delta function is located a minimum distance away from all others and such that the autocorrelation of the message template yields as close as possible, a delta function. That is, the bits are placed such that the message template autocorrelation sidelobes are of minimal amplitude.

Now, correlation of the extracted region with a zero mean carrier guarantees that the extracted circularly shifted message M′(x,y) is also zero mean. If we call the message template, T(x,y), then the absolute value of the extracted template must be practically equivalent to a circularly shifted message template. That is,

|M′(x,y)|=T(x,y)*δ(x−Δx,y−Δy) (7)

This implies, due to the autocorrelation property of the message template, that the shift from the origin of the message can be derived by correlating |M′(x,y)| with T(x,y), since:

|M′(x,y)| [symbol] T(x,y)=δ(x−Δx,y−Δy) (8)

Therefore, the result of the correlation will be a 128×128 image, whose highest peak will be located at the desired shift distance, (Δx,Δy). This peak location can be used to correctly orient the interpretation of the embedded bits.

Following the above prescription for data embedding results in a highly robust system for data hiding. The algorithms have been shown to work under very stressful conditions such as printing/scanning, cropping, wrinkling, and marking, skewing and mild warping.

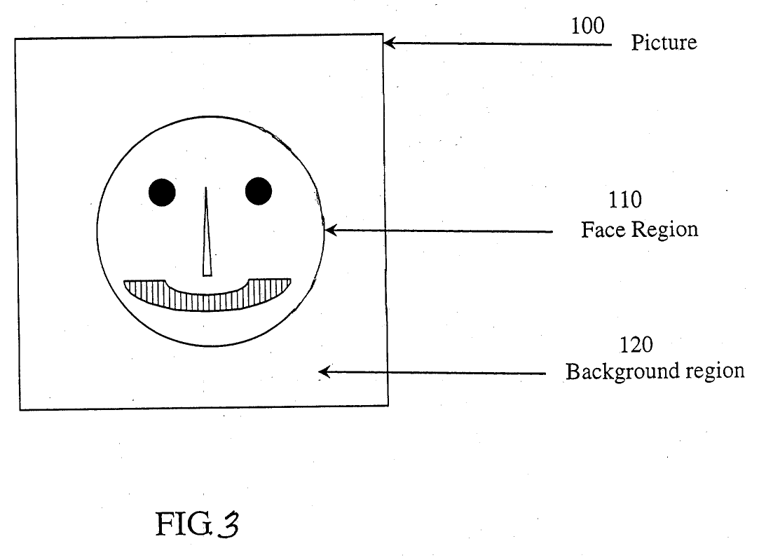

FIG. 3 shows a picture 100 of a face. The picture is divided into a face region 110 and a background region 120. Experience has shown that most persons prefer the face region slightly sharper than the background region. One way to do this is to sharpen the face and blur the background region at the time of capture or at the photofinisher.

However, there are many advantages to sharpening the face and blurring the background using sharpening and blurring strengths that are a function of the target display characteristics. If the target device is unknown, the face region and the background region can be processed in an “on-demand” fashion. That is, as the image bits are headed for the display device, the class information would be read and translated to an enhancement parameter and applied before or during the rendering process.

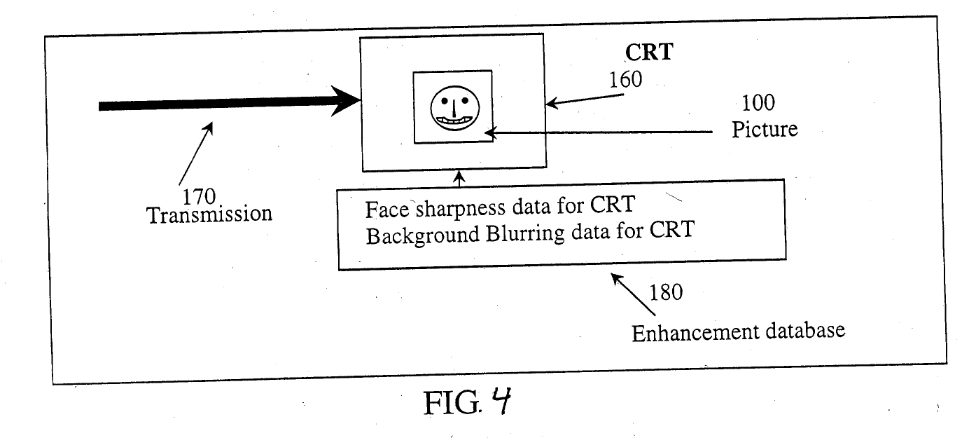

FIG. 4 is a diagram demonstrating the components of such a system. The face image 100 is transmitted 170 to the CRT (cathode ray tube) 160. Before it is displayed, the embedded data is extracted. If the local data being extracted is background 120 a blurring filter is applied. If the local data is face region 110, a sharpening filter is applied. The specific filters used are customized for the make of the CRT. This implies that an enhancement database 180 must be available. The database can simply be a ROM chip that is preprogrammed by the manufacturer. Alternatively, the database can be downloaded from a third party for further customization. The enhancement database 180 would be significantly different for the same image if the display device were an ink-jet printer, a thermal dye printer, silver halide printer, LCD display, OLED display or any other kind of display technology.

Having the option for downloading or customization of the enhancement database 180 can be valuable for persons viewing images for different purposes. A law enforcement organization for example, cares little about esthetics and much about information accuracy while an artist cares very much about esthetics. These differences in preferences can also lead to differences in the enhancement database.

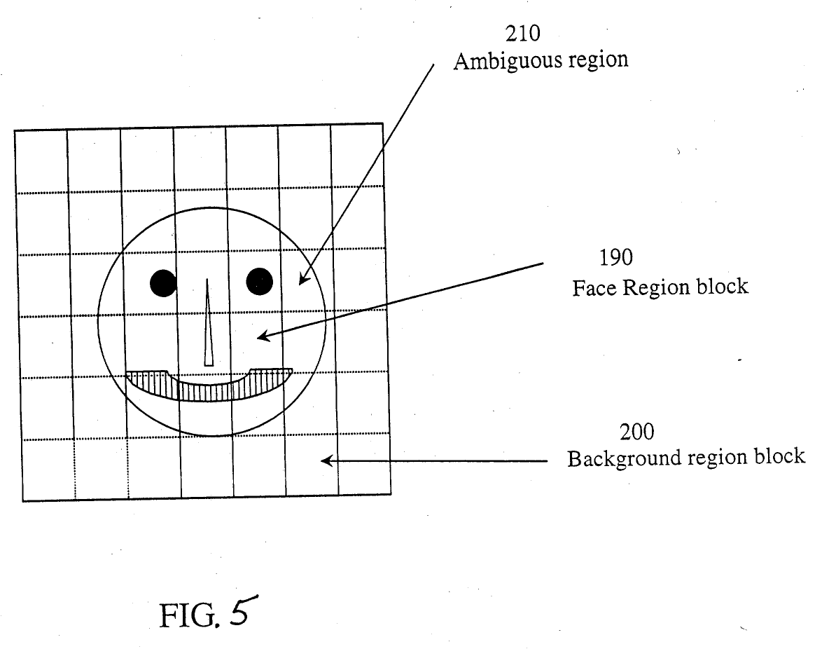

Using the data embedding algorithms described above produces a problem using this system that has not yet been confronted. FIG. 5 is intended to clarify the problem. FIG. 5 shows the picture of a face 100 divided into blocks. Each block has an embedded signal using the techniques of data embedding described above. Each block in FIG. 5 has embedded bits designating the class of the block. Three classes or kinds of blocks are called out in the figure. They are face region, background region and ambiguous regions. A face region block 190 is clearly entirely within the face region. Therefore, the enhancement parameter associated with the strength of sharpening of the face could be applied to this block without problem. Background region block 200, similarly, can be blurred consistent with the desired blurring strength. A problem arises on the border of the face region 190 and the background region 200. The problem area is called an ambiguous region 210. One simple way to confront an ambiguous region is to do nothing. Since the borders of the ambiguous region are either sharper or smoother, doing nothing can result in an average sharpness that is not objectionable. However, there is a way around this that is more elegant and can be applied to smaller features. Instead of tiling the dispersed message, that is, the term,

M(x,y)*C(x,y) (9)

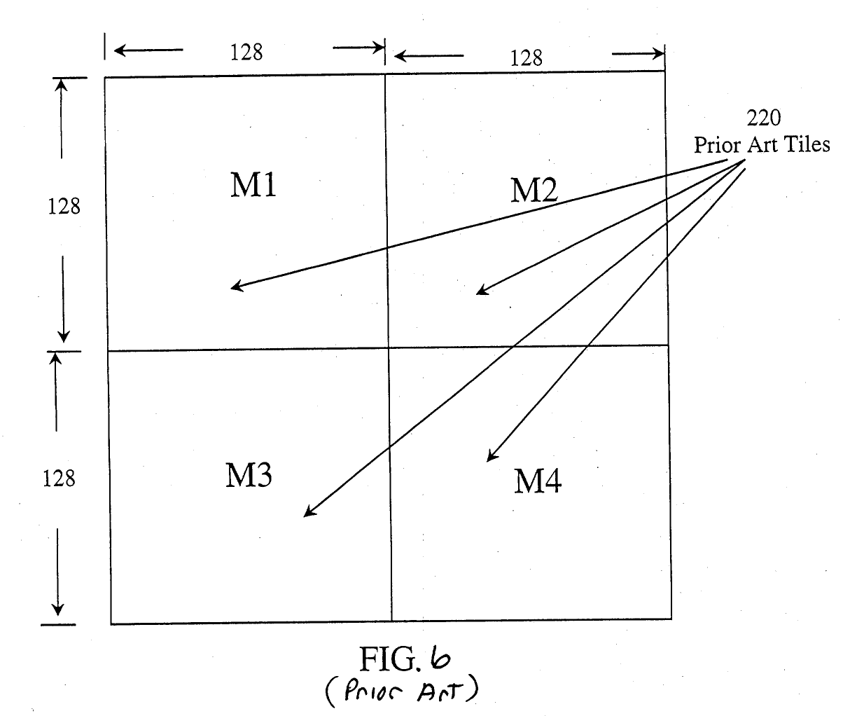

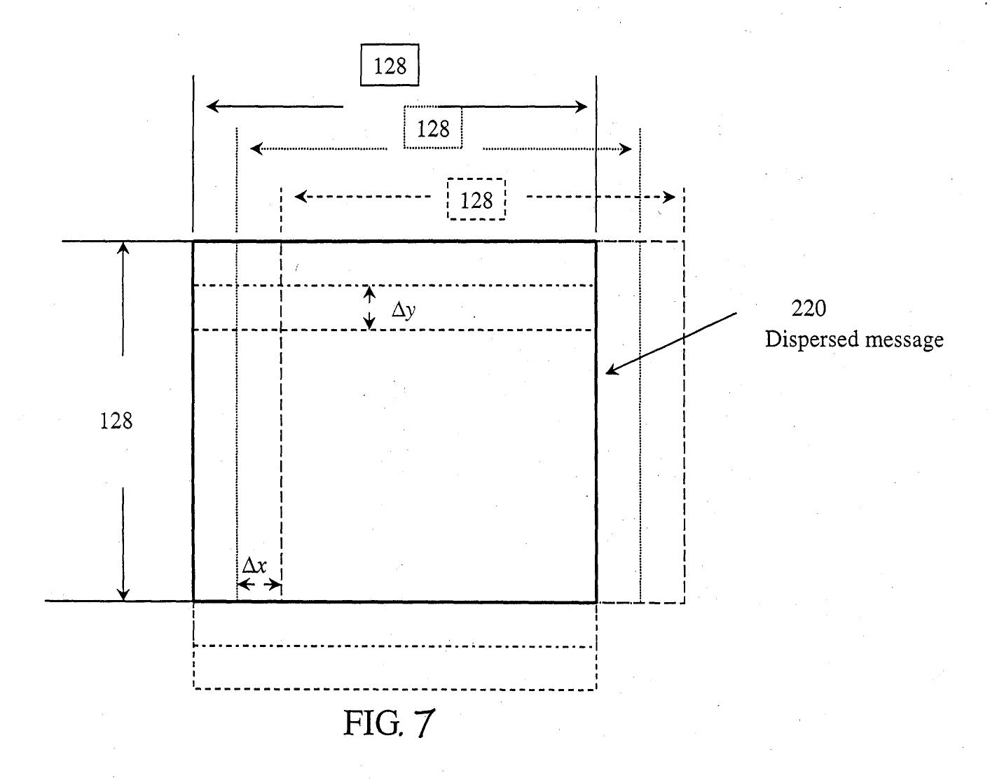

found in equation (1) above, across the image, stagger it at a desired “resolution”. Staggering the dispersed message results in overlap of the dispersed messages. FIG. 6 shows the prior art way of abutting dispersed messages (prior art tiles) 220 next to each other. The message in each square M1, M2, M3 and M4 containing a feature code can only designate a feature associated with each of the 128×128 regions. FIG. 7 shows the concept of staggering. Each dispersed message is still 128×128 but the tiling period is reduced to a desired resolution (Δr,Δy). If a feature has been classified at every (Δr, Δy) increment in an image, a dispersed message is calculated according to Eq. 9 above and added to the image at the position of the feature. The only changes to the prior art algorithm are in the amplitude at which the dispersed message 220 is multiplied. Since many of these dispersed messages will be added to the image at overlapping locations, the present invention found that the amplitude (that is, term α in Eq. 1) should be reduced (in the preferred embodiment, multiply it by {(Δx*Δy)/(128*128)}^{1/2}) to keep the invisibility of the watermark at a level consistent with prior art.

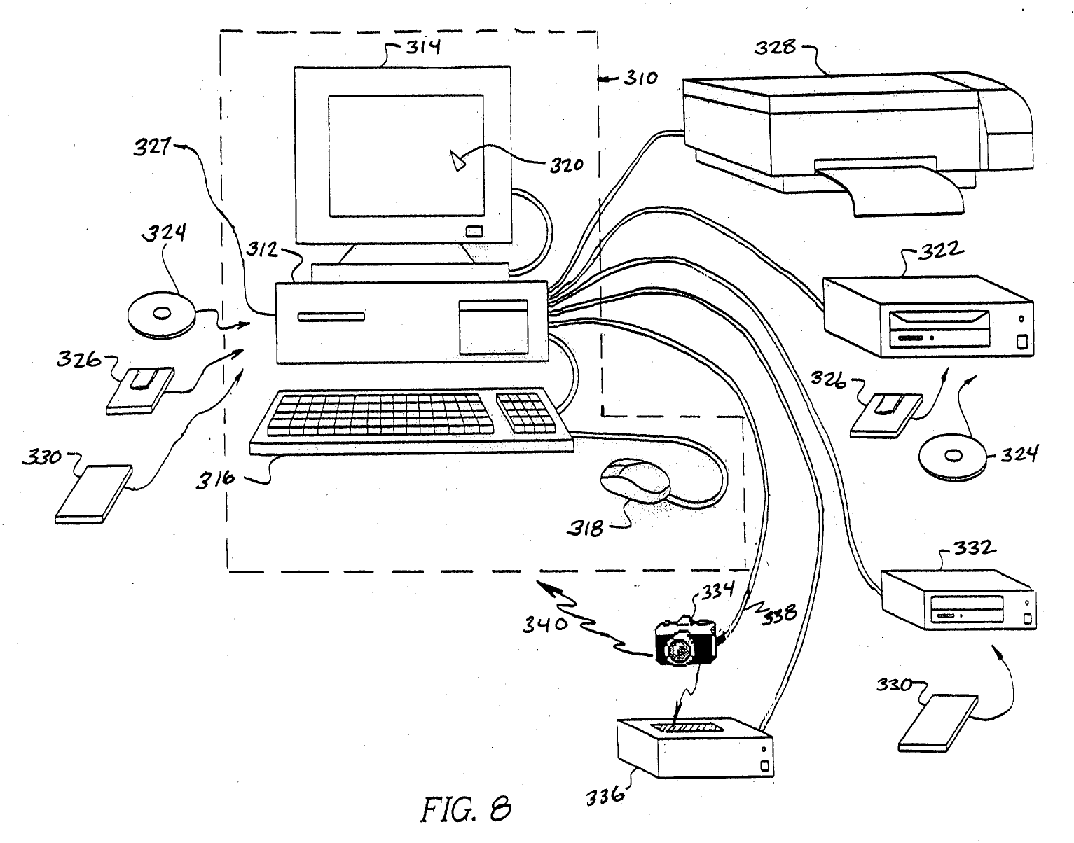

Referring to FIG. 8, there is illustrated a computer system 310 for implementing the present invention. Although the computer system 310 is shown for the purpose of illustrating a preferred embodiment, the present invention is not limited to the computer system 310 shown, but may be used on any electronic processing system such as found in home computers, kiosks, retail or wholesale photo-finishing, or any other system for the processing of digital images. The computer system 310 includes a microprocessor-based unit 312 for receiving and processing software programs and for performing other processing functions. A display 314 is electrically connected to the microprocessor-based unit 312 for displaying user-related information associated with the software, e.g., by means of a graphical user interface. A keyboard 316 is also connected to the microprocessor-based unit 312 for permitting a user to input information to the software. As an alternative to using the keyboard 316 for input, a mouse 318 may be used for moving a selector 320 on the display 314 and for selecting an item on which the selector 320 overlays, as is well known in the art.

A compact disk-read only memory (CD-ROM) 324, which typically includes software programs, is inserted into the microprocessor-based unit 312 for providing a means of inputting the software programs and other information to the microprocessor-based unit 312. In addition, a floppy disk 326 may also include a software program, and is inserted into the microprocessor-based unit 312 for inputting the software program. The compact disk-read only memory (CD-ROM) 324 or the floppy disk 326 may alternatively be inserted into externally located disk drive unit 322 which is connected to the microprocessor-based unit 312. Still further, the microprocessor-based unit 312 may be programmed, as is well known in the art, for storing the software program internally. The microprocessor-based unit 312 may also have a network connection 327, such as a telephone line, to an external network, such as a local area network or the Internet. A printer 328 may also be connected to the microprocessor-based unit 312 for printing a hardcopy of the output from the computer system 310.

Images may also be displayed on the display 314 via a personal computer card (PC card) 330, such as, as it was formerly known, a PCMCIA card (based on the specifications of the Personal Computer Memory Card International Association) which contains digitized images electronically embodied in the PC card 330. The PC card 330 is ultimately inserted into the microprocessor-based unit 312 for permitting visual display of the image on the display 314. Alternatively, the PC card 330 can be inserted into an externally located PC card reader 332 connected to the microprocessor-based unit 312. Images may also be input via the compact disk 324, the floppy disk 326, or the network connection 327. Any images stored in the PC card 330, the floppy disk 326 or the compact disk 324, or input through the network connection 327, may have been obtained from a variety of sources, such as a digital camera (not shown) or a scanner (not shown). Images may also be input directly from a digital camera 334 via a camera docking port 336 connected to the microprocessor-based unit 312 or directly from the digital camera 334 via a cable connection 338 to the microprocessor-based unit 312 or via a wireless connection 340 to the microprocessor-based unit 312.

In accordance with the invention, the algorithm may be stored in any of the storage devices heretofore mentioned and applied to images in order to extract information used to embed steganographic data.

The invention has been described in detail with particular reference to certain preferred embodiments thereof, but it will be understood that variations and modifications can be effected within the spirit and scope of the invention.

### Parts List

10 binary message

20 iconic message

100 picture of a face (face image)

110 face region

120 background region

160 CRT

170 transmission

180 enhancement database

190 face region block

200 background region block

210 ambiguous region

220 dispersed messages (prior art tiles)

310 computer system

312 microprocessor-based unit

314 display

316 keyboard

318 mouse

320 selector

322 externally located disk unit

324 compact disk-read only memory (CD-ROM)

326 floppy disk

327 network connection

328 printer

330 personal computer card (PC card)

332 externally located PC card reader

334 digital camera

336 camera docking port

338 cable connection for digital camera

340 wireless connection for digital camera

What is claimed is:

1. A method of steganographic encoding data into an image which encoded data is related to image processing functions that may be used to process the image, the method comprising the steps of:
a) providing a dispersed message dimension;
b) providing a grid spacing value;
c) providing an array of object identifiers and associated object locations based on the grid spacing value;
d) embedding an object identifer at a first location into the image; and
e) embedding a second object identifier at a second location, wherein the the second location is an integer, non-zero multiple of the grid spacing value.

2. The method as in claim 1, wherein the grid spacing value is less than the dispersed message dimension.

3. A method of displaying an image having steganographic encoded data which encoded data is related to image processing functions that may be used to process the image, the method comprising the steps of:
a) extracting a first object identifer at a first location from the image;
b) extracting a second object identifier at a second location from the image;
c) performing an image processng function at the first location in accordance with the first object indentifier; and
d) performing an image processng function at the second location in accordance with the second object identifier.

4. The method as in claim 3 further comprising the step of providing the first location and second location on a grid and the extractions are performed using a dispersed message whose dimension is greater than the grid spacing value.

5. The method as in claim 3 further comprising the step of rendering an image on a device in accordance with claim 1.

6. A system for processing a digital image, the system comprising:
a) a mechanism for steganographically embedding spatially varying metadata;
b) a mechanism extracting the steganographically embedded spatially varying metadata; and
c) a mechanism for using the extracted spatially varying metadata to determine one or more digital image processing steps.

7. The system as in claim 6 further comprising the steps of applying one or more of the determined processing steps to the digital image.

8. The system as in claim 7 wherein the applying step includes applying either indiviually or in any combination scene balance, tone scale manipulation, sharp adjustment, noise reduction, and defect correction.
